(19) United States
(12) Patent Application Publication
(10) Pub. No.: US 2007/0189669 A1
(43) Pub. Date: Aug. 16, 2007

(54) Integrated wavelength selective grating-based filter

(76) Inventors: Maurizio Tormen, Belluno (IT); Marco Romagnoli, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/631,780

(22) PCT Filed: Jul. 22, 2004
(86) PCT No.: PCT/EP04/08200

§ 371 Date: Jan. 8, 2007

(51) Int. Cl. G02B 6/34

(52) U.S. Cl. 385/37

(57) ABSTRACT

A wavelength selective grating-based filter includes a planar waveguide which includes a core surrounded by a cladding, the cladding including a lower cladding, the core being placed above the lower cladding, a lateral cladding adjacent to a first and a second opposite lateral sides of the core, and an upper cladding, said upper cladding being positioned above said core and lateral cladding. The waveguide also includes a grating structure, including a first and a second plurality of grating trenches formed in the lateral cladding in proximity of the first and second opposite lateral sides of the core, respectively. The first and second plurality of grating trenches are covered by the upper cladding.

### TECHNICAL FIELD

The present invention relates to a wavelength selective filter comprising a grating, and it is directed in particular to the realization of integrated wavelength division multiplexer/demultiplexer optical devices in which light at a specific wavelength (or specific wavelengths) can be added or dropped in an efficient manner.

### TECHNOLOGICAL BACKGROUND

Wavelength division multiplexed (WDM) or dense WDM (DWDM) optical communication systems, require the ability to passively multiplex and demultiplex channels at certain network nodes and, in some architecture, to add and drop channels at selected points in the network, while allowing the majority of the channels to pass undisturbed.

Diffraction gratings, for example Bragg gratings, are used to separate the independent optical channels, which have different transmission wavelengths and are transmitted along a line, by reflecting one wavelength into a separate optical path, while allowing all other wavelengths to continue onward through the original line.

In particular, gratings are used to isolate a narrow band of wavelengths, thus making possible to construct a device for use in adding or dropping a light signal at a predetermined centre wavelength to or from a fiber transmission system. This centre wavelength is known as Bragg wavelength λ_{B}. The Bragg wavelength is related to the effective index n_{eff} of the waveguide in which the grating is realized and to the grating period Λ(z) (both typically being function of the coordinate z along the waveguide axis) by the following Bragg phase matching condition:
λ_{B}=2n_{eff}Λ(z).

Therefore, by selectively reflecting a predetermined wavelength band, an optical Bragg diffraction grating may be interposed in an optical transmission line to filter a multi-wavelength optical signal.

A possible device configuration for an add/drop filter incorporating gratings is for example the Mach-Zehnder interferometer (MZI). In particular, a MZI comprises generally two waveguides, each of which includes an interferometer arm that extends between two coupling regions. In the two arms of the interferometer, a Bragg grating is commonly realized.

Gratings in a fiber or in a waveguide are periodic or pseudo-periodic variations in the fiber/waveguide. Gratings may be formed, for example, by physically impressing a modulation on the fiber/waveguide, which is induced by a variation of the refractive index of the fiber/waveguide. The photoelastic or the photorefractive effect can be used to induce the refractive index variation.

A method for achieving gratings on a waveguide is by making use of the photosensitivity of certain types of materials forming the waveguide. For example, a conventional silica fiber doped in a certain region(s) with germanium becomes photosensitive, making the refractive index of that region(s) of the optical fiber susceptible to increase upon exposure to UV radiation. An interference pattern is then formed by UV laser radiation (using, for example, a phase mask during the exposure) to create an optical fiber grating.

An example of a planar waveguide based Mach-Zehnder interferometer (MZI) is disclosed in “Low-Loss Planar Lightwave Circuit OADM with High Isolation and No Polarization Dependence” published in IEEE Photonics Technology Letters, vol. 11, no 3, pp. 346-348. Two Bragg gratings are written one after the other in the two arms of the MZI using an ArF excimer laser. Trimming of the path length by uniform UV exposure of the interferometer arms away from the gratings is used to compensate for the imbalance in the two gratings that noticeably disrupts the optical path length equilibrium.

In “Integrated-optical Mach-Zehnder add-drop filter fabricated by a single UV-induced grating exposure”, published in Applied Optics, Vol. 36, no 30, pp. 7838-7845, a waveguide Mach-Zehnder interferometer fabricated in P₂O₅-doped SiO₂ channel waveguides on silicon substrate is described. The gratings in the cores of the arms of the MZI are realized in a single UV exposure to avoid UV trimming.

In U.S. Pat. No. 6,091,870 in the name of Corning Incorporated, optical signal devices comprising a pair of spaced apart cladding layers made of a material having a first refractive index, having sandwiched therebetween a core layer including a pair of waveguides having a second refractive index greater than the first refractive index and a grating region including a filter extending through the core and cladding layers for causing a single wavelength of light of a multiple wavelength light source to be segregated therefrom are disclosed. The upper, lower and core layers are made of a photosensitive material that enables the application of a refractive grating system by photolithography.

Applicants have noted that the use of UV radiation for achieving fiber gratings has some drawbacks. UV exposures generally have to be precisely localized and well-controlled, therefore in case of realization of several gratings in a single exposure, which would be desirable to reduce production costs, technological complexity is expected. Additionally, aligning problems of the phase mask may arise.

Moreover, in case of realization of two (or more) gratings that have to be as equal as possible, such as in case of gratings generally realized in the two arms of a MZI, trimming may be necessary to compensate for the UV induced non-identity.

Alternatively, gratings can be realized by etching a corrugation into a waveguide. Etching is preferred when a parallel integrated manufacturing process is desired (i.e. many gratings can be obtained in a single manufacturing step). Additionally, integrated Bragg gratings can be built in materials that are not photorefractive, and stronger gratings can be realized since the grating strength is not limited by the photorefractive effect.

In “Add-drop filter based on apodized surface-corrugated gratings” published in J. Opt. Soc. Am. B, vol. 30, no 3, pp. 417-423, the fabrication of a grating-based add-drop filter in SiON planar waveguide technology is reported. The described filter is configured as a MZI. The waveguide core material, which consists in silica doped with nitrogen, is deposited on a silicon wafer. The gratings are defined before the ridge waveguides are structured, and an electron beam machine is used to expose the gratings in a suitable resist. Subsequently, a lift-off phase and an ion etching phase follow to realize the gratings on the SiON cores. In particular, gratings extending over both arms of the MZI are fabricated.

In all the above cited prior-art documents, the grating(s) included in the filter device is (are) realized either on the core of the waveguide or in the core and in the cladding of the same.

Applicants have noticed that, particularly in case of gratings that can select a relatively small bandwidth and exhibit a high reflectivity (i.e. higher than 99%), the realization of grating(s) in the core of the waveguide is technologically demanding.

The characteristics of a grating which perturbs the optical mode propagating in the waveguide are selected according to the desired spectral response. Given the desired spectral response, an appropriate modulation of the refractive index of the propagating mode, Δn_{eff}, is to be selected. Applicants have noted that, since the electromagnetic field intensity is high in the core region, the corrugation forming the grating has to produce a small modulation in the refractive index in order to perturb the propagating optical mode. Typically, the effective modulation of Δn_{eff} is of the order of 10⁻⁴-10⁻³ for application in filters for WDM or DWDM systems with channel spacing from 50 to 200 GHz. Applicants have remarked that, in order to change the grating strength, extremely small variations to this small perturbation has to be introduced in the waveguide core. Due to the above considerations, the tolerances in the grating fabrication are extremely low and minimal fabrication errors may cause malfunctioning of the device.

In “Periodical Corrugated Structure for Forming Sampled Fiber Bragg Grating and Long-Period Fiber Grating with Tunable Coupling Strength”, published in Journal of Lightwave Technology, Vol. 19, no 8, pp. 1212-1220, a corrugated structure is disclosed, comprising a fiber Bragg grating realized in the core region of a waveguide and a long-period Bragg grating realized in the cladding of the same waveguide. When a tensile force is applied to the corrugated structure, due to the differential strain distribution and the photoelastic effect, a superstructure is induced in the core region of the waveguide in superposition with the uniform fiber Bragg grating, through the modulation of Bragg grating periods and the effective indices of core mode. The structure realized in this paper has tunable periodic grating modulation. Two gratings are realized, both in the core and in the cladding.

Another known problem in the realization of gratings is the exhibited losses in transmission at wavelength other than the desired reflection wavelength. Strong Bragg gratings generally exhibit such losses in transmission for wavelength shorter than the wavelength of the fundamental loss band. These losses are attributed in large part to coupling of light from the guided core mode to “back-propagating” cladding modes when light reflects from a Bragg grating. Light coupled into one of these modes represents a loss of light at that wavelength, since light in these cladding modes is typically adsorbed or lost out the side of the optical waveguide or fiber after travelling a short distance. A description of this phenomenon and a proposed solution can be found for example in U.S. Pat. No. 6,408,118 in the name of Agere Systems Guardian Corp.

The U.S. Pat. No. 6,628,850 in the name of General Photonics Corporation discloses a modulator comprising a grating realized in a fiber cladding layer by formation of periodic trenches. These trenches are filled with a dielectric material whose refractive index can be varied in response to an external control signal. The refractive index of the dielectric material has at least two distinctly different values: a first value that is substantially equal to the refractive index of the cladding material in response to a first value of the control signal, and a second value that is sufficiently different from the refractive index of the cladding to effectuate the desired mode coupling. The disclosed modulator operates as a switch.

In this patent, two different embodiments are disclosed. In the first embodiment, two gratings are realized in the cladding region on two opposite sides of a fiber core. In the second embodiment, a waveguide is disclosed, on the upper cladding layer of which a single grating is realized. Additionally, it is mentioned that in this second embodiment an additional grating may be realized on the lower cladding layer of the same waveguide.

Applicants have noted that the realization of asymmetrical waveguides, in which a single grating is realized in the upper cladding layer, may lead to a device in which losses due to the coupling to the cladding modes are relevant. Applicants have additionally observed that the realization of a symmetric structure in which a grating is realized also in the lower cladding layer, on top of which the core layer is deposited, is technologically extremely complex.

Moreover, the fact that the trenches forming the grating have to be filled with an additional material is a troublesome operation in case of trenches having a small width, e.g., of 200-300 nm.

A particularly desiderable additional characteristic of optical filters is wavelength tunability, so that the Bragg wavelength may be changed, in order to increase the flexibility of the network. The goal of a tunable filter is therefore to select one channel (or several channels) in a given incoming input optical signal and transmitting all the other channels through the filter, said channel being changeable.

A proposed tunable optical filter is disclosed in U.S. Pat. No. 6,389,199 in the name of Corning Incorporated. The disclosed devices, among which a MZI is depicted, are optical signal devices having fine tuning means that provide for an efficient control of the wavelength of light which is to be segregated from a multiple wavelength light signal. In particular Bragg gratings are realized at least in the core of the waveguides forming the two arms of a MZI through photochemical techniques. The cores of the two waveguides are realized in a thermo-sensitive polymer, i.e. in a material the index of refraction of which changes with temperature. In order to tune the filtered wavelength, a heater is provided in the grating region.

In this patent, gratings are realized in the core regions of the waveguides.

### SUMMARY OF THE INVENTION

Applicants have focused their attention on wavelength-selective filters comprising grating structures and realized on planar waveguides. One of the goals of the present invention is to realize an integrated-optical filter in which the connection between the integrated filter and a standard external fiber of a transmission system is simple and has low coupling losses.

Planar waveguides can be of buried-core type, i.e., the core is surrounded by one or more cladding layers, or of ridge type, in which the core is placed on the surface of a cladding layer. Applicants have noticed that, in case of usage of ridge waveguides, in which a portion of the core is in direct contact with air, instead of buried-core waveguides, the overall filtering element has higher total losses due—among others—to high scattering processes caused by the high refraction index difference between the waveguide core and air. Additionally, in order to obtain the same performances of a filter comprising a planar waveguide, the same filter including a ridge waveguide needs longer gratings, thus enlarging the device's overall dimensions.

The present invention generally relates to a buried-core planar waveguide. In this context, a buried-core waveguide refers to a waveguide in which the waveguide core is surrounded by a cladding. In particular, a grating-based filtering element comprises a planar waveguide including a lower cladding on top of which a core is formed, a lateral cladding adjacent to two opposite lateral sides of the core and an upper cladding positioned above the core and the lateral cladding. In the lateral cladding, a grating structure is realized, which comprises two pluralities of trenches which are positioned in proximity to the two opposite lateral sides of the core so as to induce a perturbation of the optical mode propagating along the waveguide. With the word “side of the core”, a core/cladding boundary surface is indicated.

The trenches realized on the filter of the present invention are formed preferably by an etching process, however any other suitable technique may be employed as well.

Preferably, the lower cladding is deposited on a substrate, such as a silicon wafer.

The term “lateral” indicating the relative positions of the core and the gratings has the following meaning in the present context. The two pluralities of trenches are said to be located “laterally” with respect to the core if each plurality is in proximity of a side of the core, the two sides being opposite one to the other. Preferably, the two pluralities are located approximately at the same distance from the substrate. With the term substrate, it is meant the lower layer on which the waveguide is fabricated, which may comprise a plurality of different layers made of different materials. Additionally, the terms “lower” and “upper” refer to the positions of the claddings with respect to the substrate. “Lower cladding” indicates the cladding adjacent to the substrate, while “upper cladding” indicates the cladding positioned above a side of the core, opposite to the side of the core facing the lower cladding. The physical orientation may be however different.

In the waveguide of the invention, no grating structure is located in the core of the waveguide.

The grating is only formed in the cladding of the same.

The term “in proximity” of the core indicates that the distance between the core of the waveguide and each plurality of trenches should be such that the grating structure can perturb the optical mode propagating in the waveguide, as it will become clearer in the following.

The pluralities of trenches of the present invention are located in the cladding layer(s) so as to create a perturbation effect on the optical modes which travel in the waveguide. Guided optical modes in waveguides are not completely confined inside the core, but their spatial distribution extends also in the cladding region. In particular, an evanescent field that generally decays as an exponential function of the distance from the core-cladding interface propagates in the cladding.

This evanescent field is modified by the presence of the grating formed in the lateral cladding and therefore the mode itself is affected by the grating. Being the electromagnetic field intensity of the mode in the cladding rather low with respect that of the core, higher tolerances are acceptable in the grating fabrication so that it becomes easier to control the grating parameters in a cladding-positioned grating than in a grating realized in the core region of the same waveguide.

Preferably, the wavelength filter of the invention is highly selective, i.e. it has a bandwidth ranging from about 10 to 400 GHz.

Preferably, the wavelength filter has a high reflectivity, i.e. higher than 99%. It is known that to obtain these characteristics, the perturbation due to the grating structure on the propagating mode has to be weak. However, due to the fact that the grating structure of the present filter perturbs only the evanescent field of the propagating mode, the grating structure has preferably a relatively high index contrast Δn_{G}, i.e. Δn_{G} is higher than or equal to 0.4. It is to be understood that the coupling between the grating and the lateral evanescent field depends also on the lateral distance, d, of the trenches from the sides of the core. A refractive index contrast Δn_{G} Of not less than 0.4 can lead to a weak but effective perturbation, i.e. of about 1×10⁻⁴≦Δn_{eff}≦2−3×10⁻³.

The distance between the trenches and the lateral sides of the core of the waveguide, d, is preferably not smaller than 50 nm. The lower limit is due to the fact that realization of a grating located extremely close to the core/cladding boundary is technologically complex and requires high accuracy. More preferably, d≧100 nm, even more preferably d is in the range from 100 to 1000 nm.

An optimum value of d is preferably to be determined on a case-by-case basis, because it depends, among others, on the desired spectral response of the filter and on the materials in which the core and claddings are realized.

Given a grating configuration, its strength is determined, among others, by the distance from the core/cladding boundary at which is located. Therefore the grating intensity may be selected choosing the position of realization, i.e. the distance d between the trenches and the core/cladding boundary.

Preferably, the trenches of the grating structures are filled with air.

Preferably, the two pluralities of trenches are realized symmetrically with respect to the longitudinal axis of the core. Due to this preferred configuration, losses due to coupling of light from the guided core mode to cladding modes are advantageously minimized.

Preferably, the two sets of trenches of the grating structure are realized simultaneously to avoid misalignments and to minimize stitching errors, which could degrade the spectral response.

The cross-section of the core of the planar waveguide included in the filter of the invention is preferably square, so that the filter is polarization-independent.

Alternatively, in case of grating exhibiting a polarization-dependent behaviour, the cross-section of the core can have a rectangular shape to compensate polarization.

In order to minimize coupling losses in case of splicing with an external fiber, the relative refractive index difference Δn_{C} between the cladding and the core of the planar waveguide in which the pluralities of trenches are realized is preferably of about 0.6-0.7%, i.e. the difference being of the order of that found in standard transmission optical fibers, in case of square core.

In case of a rectangular core, it is preferable to have a different refractive index difference from that one of the fiber in order to have mode-matching.

Therefore, the preferred Δn_{C} depends on the selected geometry of the waveguide.

According to another aspect of the invention, the filtering element is preferably tunable, i.e. the Bragg wavelength at which the grating(s) is resonant may be changed. In particular, the filtering element may be thermo-optically tunable. Therefore, tuning elements (for example a heater) are positioned on top of the upper cladding in correspondence of the grating structure.

The filter according to the present invention can be used in add and drop optical devices. Preferably, the optical filter of the present invention includes a Mach-Zehnder interferometer (MZI). The MZI includes two arms in both of which a grating structure is realized in the cladding as above described.

Even more preferably, a cascade of a plurality of filters, for example of MZIs according to the present invention, is realized in order to obtain a multichannel add/drop signal optical device.

### BRIEF DESCRIPTION OF THE DRAWINGS

Further features and advantages of a wavelength selective grating-based filtering element according to the present invention will become more clearly apparent from the following detailed description thereof, given with reference to the accompanying drawings, where:

FIG. 1 is a schematic top-view of a filtering element realized according to the present invention;

FIG. 2 is a lateral section along the line A-A of the filtering element of FIG. 1;

FIG. 3 is a lateral section along the line B-B of the filtering element of FIG. 1;

FIGS. 4a and 4b are two graphs showing respectively the simulated and experimental exemplary optical characteristics of the filtering element of FIG. 1, the continuous lines represent the reflection and the spectra;

FIG. 5 is a graph showing an example of an input signal to the filtering element of FIG. 1;

FIG. 6 and FIG. 7 are two graphs showing two different output signals from the filtering element of FIG. 1 at two different operative temperatures, T=25° C. and T=65° C. respectively;

FIG. 8 is a SEM prospective view partially sectioned of the filtering element of FIG. 1;

FIGS. 9-15 are schematic cross-sectional lateral views of phases for the realization of the filtering element of FIG. 1 according to an embodiment of the present invention;

FIG. 16a is a schematic top view of a first embodiment of a filter including the filtering element of FIG. 1 of the present invention;

FIG. 16b is a graph showing the reflection grating spectrum of the filter of FIG. 16a;

FIG. 17a is a schematic top view of a second embodiment of a filter including the filtering element of FIG. 1;

FIG. 17b is a graph showing the reflection grating spectrum of the filter of FIG. 17a;

FIG. 18a is a schematic top view of a third embodiment of a filter including the filtering element of FIG. 1;

FIG. 18b is a graph showing the reflection grating spectrum of the filter of FIG. 18a;

FIG. 19a shows an add/drop optical devices including a plurality of filters of FIGS. 16a, 17a, 18a;

FIGS. 19b-19e are four graphs showing the reflection grating spectra of the add/drop device of FIG. 19a.

### PREFERRED EMBODIMENTS OF THE INVENTION

With initial reference to FIGS. 1-3, 100 indicates a wavelength selective grating-based optical filtering element realized according to the teaching of the present invention.

The filtering element 100 includes a planar waveguide 4 comprising a core 2 completely surrounded by a cladding 1, preferably realized on a substrate 3 such as a silicon wafer.

The substrate 3 may comprise a silicon based material, such as Si, SiO₂, doped-SiO₂, SiON and the like. Other conventional substrates will become apparent to those skilled in the art given the present description.

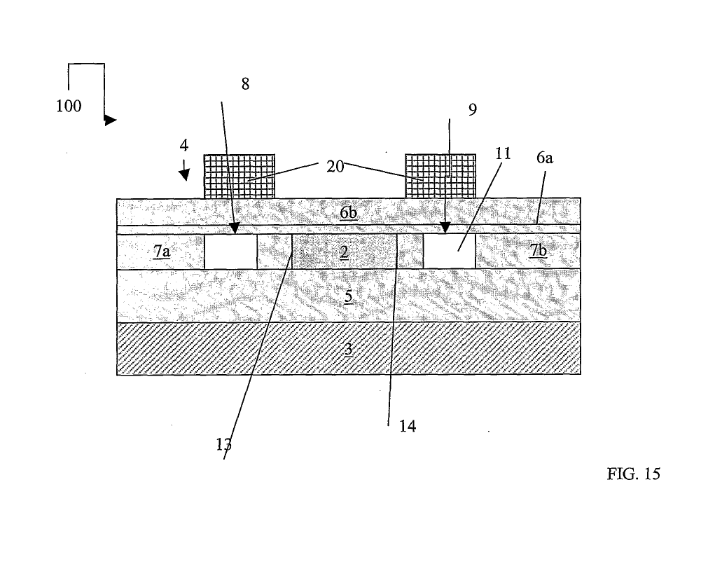

Three different portions of the cladding 1 can be identified, which can be more clearly seen in FIG. 15. To simplify the terminology in the following description, with the term “side of the core” a portion of the surface boundary between the core and the cladding will be indicated. In case of a core having rectangular or square cross-section, a side indicates a rectangular (or square) surface of the core; in case of a cylindrical core, a side indicates a portion of the cylindrical surface of the core.

With reference to FIG. 15, a lower cladding 5 is defined as the portion of the cladding 1 delimited between the substrate 3 and a side of core 2 approximately facing the substrate 3, i.e., the lower side. An upper cladding 6 is the portion of the cladding 1 placed above a side of the core 2 opposite to the substrate 3, i.e., the upper side, and a lateral cladding 7, which is composed essentially by two distinct regions 7a, 7b separated longitudinally by the core 2. The lateral cladding 7 is essentially the remaining cladding portion sandwiched between the upper and lower cladding 5, 6 which extends from the lateral sides of the core 2 in the two lateral (e.g. parallel to the substrate) directions.

The planar waveguide 4 is preferably realized in semiconductor-based materials such as doped or non-doped silicon based materials and other conventional materials used for planar waveguides. Preferably, the core refractive index n_{core} is comprised between 1.448 and 3.5, while the cladding refractive index n_{cladding} is comprised between 1.446 and 3.5. Therefore the effective refractive index of the waveguide is preferably comprised between 1.448 and 3.5.

In a preferred embodiment of the invention, the core 2 is made in Ge-doped SiO₂ having a refractive index n_{core}=1.456, the lower and upper cladding 5, 6 are realized in undoped SiO₂ (refractive index n_{lower}=nᵤₚₚₑᵣ=1.446), whilst the lateral cladding 7 is realized in borophosphosilicate glass (BPSG, which is silicon dioxide in which boron and phosphorus are added). BPSG has a refractive index essentially equal to that of undoped SiO₂. It is understood that other materials may be employed as known by those skilled in the art. BPSG is preferred as material for the lateral cladding because of its good gap-filling capability.

Preferably, the refractive indices of the lower, upper and lateral cladding 5, 6, 7 are substantially equal one another, i.e. the difference between any couple of above mentioned cladding refractive indices is of the order of 10⁻⁴ or lower.

Additionally, the refractive index of the core 2 is higher than the refractive index of the lower, upper and lateral cladding 5, 6, 7.

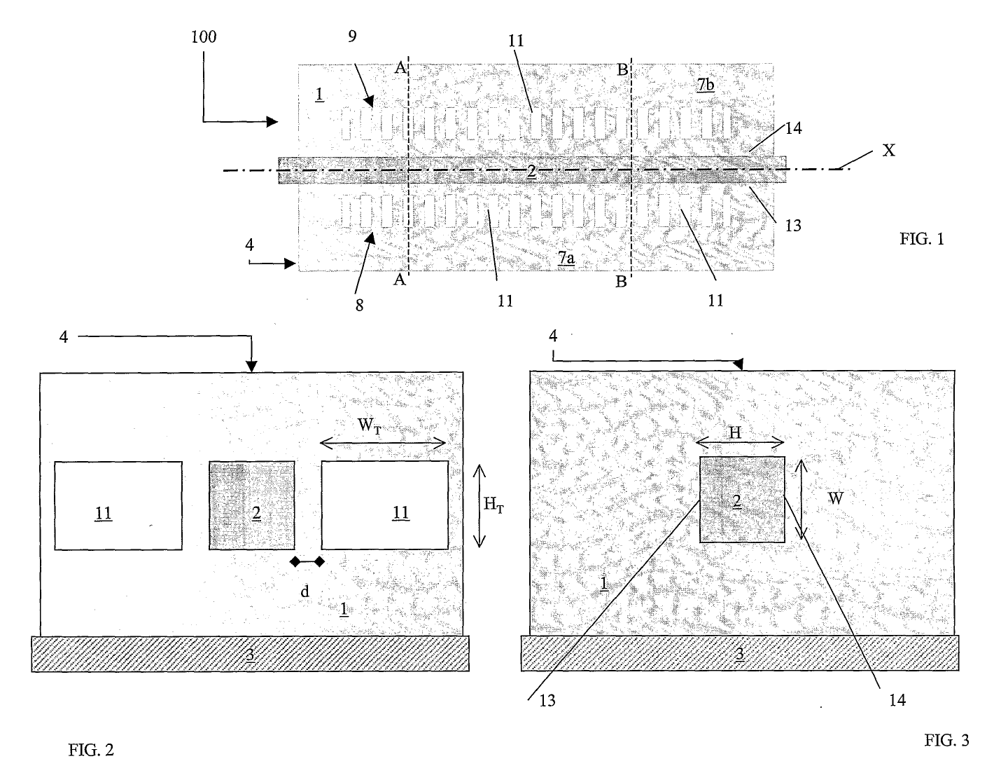

As shown in FIGS. 2 and 3, preferably the core 2 of the waveguide 4 has a square cross-section.

This geometry advantageously renders the device polarization-independent. Also a circular cross-section might achieve the same goal.

Preferably, the width W and the height H of the core 2 are both comprised between 1 and 9 μm, for example in the embodiment of FIGS. 2 and 3 the core 2 has a cross section of 4.5×4.5 μm². According to a particular characteristic of the present invention, a grating structure, including two pluralities of trenches 8, 9, is realized on the lateral cladding 7 of the waveguide 4. In particular, each plurality of trenches—each trench being indicated with 11 and all trenches being preferably parallel one another—, is located in the proximity of a lateral side 13, 14 of the core 2 of the waveguide 4. The first and second plurality of trenches 8 and 9 are realized along the core 2, preferably symmetrically with respect to a longitudinal axis X of the core 2.

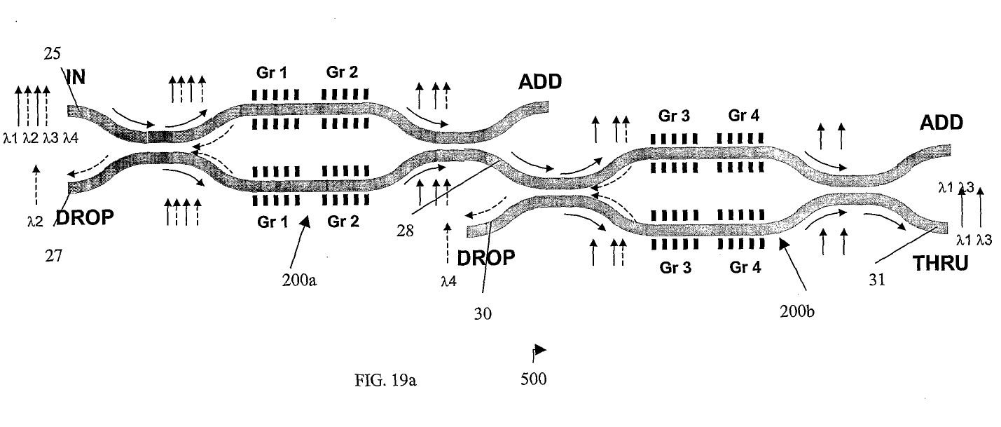

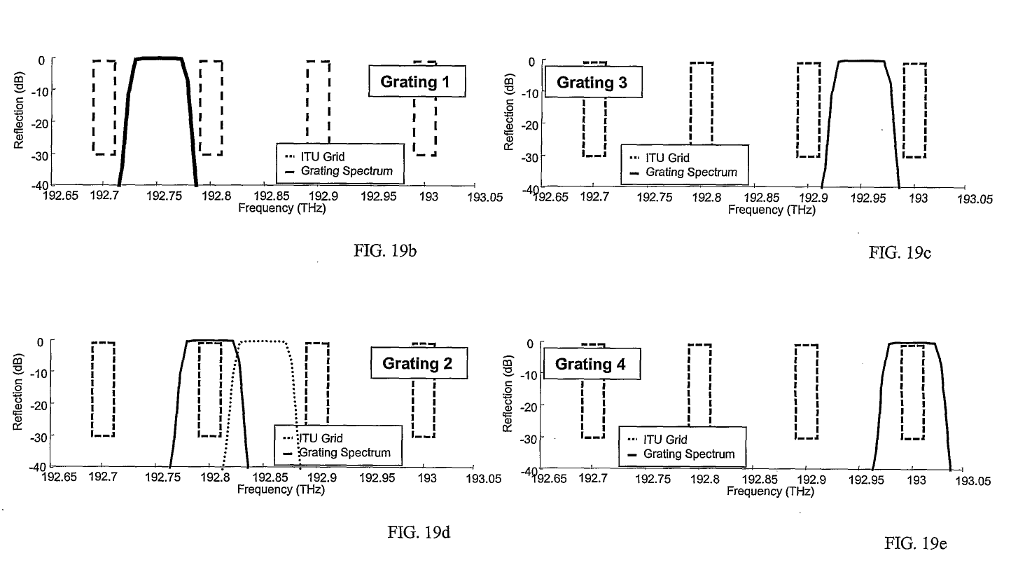

In FIGS. 1 and 15, a waveguide 4 comprising two symmetric pluralities of trenches 8, 9 realized in the proximity of the two opposite lateral sides 13, 14 of the core 2 is depicted, however the number of the pluralities of trenches realized on the lateral cladding 7 of the planar waveguide 4 can be higher than two and it depends on the desired filter application (for example in FIG. 19a, which will be described in the following, each arm of the Mach-Zehnder filter therein depicted comprises four pluralities of trenches).

The distance d between the core/cladding surface boundary and the trenches 11 is preferably larger than 50 nm and it is more preferably comprised between 50 nm and 2500 nm, even more preferably between 100 and 1000 nm. In the preferred example of FIGS. 2 and 3, the distance d=500 nm. A distance smaller than about 50 nm is less preferred because it may pose technological difficulties in the positioning of the trenches 11 with respect to the lateral sides 13, 14 of the core 2 and requires high fabrication accuracy.

The grating trenches 11 are preferably “empty”, e.g., left under vacuum, filled with air or with another gas, such as an inert gas.

Preferably, the trenches 11 are filled with air (nₐᵢᵣ=1), so that the refractive index contrast Δn_{G} in the grating along the propagation direction (which is the X axis) of a mode in the waveguide 4 is rather high. More preferably, the material of the lateral cladding and the material filling the trenches are chosen so that Δn_{G}≧0.4. For example, in case of a cladding made of undoped silica and trenches filled with air, Δn_{G} is of about 0.446. Preferably, the grating structure is configured so as to obtain an effective index contrast of 1×10⁻⁴≦Δn_{eff}≦2−3×10⁻³.

In a preferred embodiment of the invention (see FIG. 2), trenches 11 have the same height H_{T} as the core 2. However any trench height can be chosen, as soon as the trenches 11 are confined within the cladding 1.

The width W_{T} of the trenches 11 (i.e. their dimension perpendicular to the X axis extending in the lateral cladding, see for example FIG. 2) is preferably higher than 500 nm and more preferably comprised between 0.5 μm and 10 μm.

The period Λ_{grating} of the grating structure, i.e. of the pluralities of trenches 8, 9 realized in the cladding 1 of the waveguide 4, is preferably comprised between 100 nm and 600 nm. Additionally, the grating duty cycle is preferably comprised between 10% and 90%. In a preferred embodiment, Λ_{grating}=536 nm and duty cycle of 50%.

The trenches 11 are covered by the upper cladding 6, the height of which is preferably chosen such that a mode propagating in the waveguide 4 is substantially wholly confined inside the waveguide 4 itself.

From the above mentioned mode confinement and from the preferred difference in refractive index Δn_{C} between the core 2 and the cladding 1 of the planar waveguide 4, a coupling between the filtering element 100 and a standard silica fiber (not shown) advantageously presents relative low losses, i.e. fiber and waveguide can be coupled with optimum efficiency.

Preferably, the upper cladding 6 comprises two different cladding layers, better shown in FIG. 15a, a first upper cladding 6a and a second upper cladding 6b, one on top of the other, which are preferably realized with materials having substantially the same refractive index.

In accordance with another aspect of the present invention, the filtering element 100 is preferably tunable, i.e. the Bragg wavelength filtered by the pluralities of graying trenches 8, 9 is changeable. Even more preferably, the filtering element 100 is thermo-optically tuned.

It is known that several materials change their refraction index with temperature. Changing the refraction index of the core or the cladding (or both) of a waveguide implies that also its effective index and thus the selected Bragg wavelength changes: λ_{B}=2n_{eff}Λ(z).

In particular, in the present case heaters 20 (an example of which is shown in FIG. 15) are placed on top of the upper cladding 6 approximately in correspondence of the grating region to heat the same. The heaters 20 may be for example electrodes of a specific resistance.

Preferably, the operating temperature range of the grating structure is of about from 0° C. to 250° C., even more preferably between 20° C. to 100° C. Given this second temperature range, the shift in the Bragg wavelength can be of about 1.2 nm.

### EXAMPLE 1

With reference to FIGS. 1-3 and 15, the lower cladding 5 is realized in SiO₂ with a thickness of 10 μm and a refractive index of n_{lower}=1.446, and it is deposited on a silicon wafer 3.

The core 2, having a 4.5×4.5 μm² cross-section, is realized in Ge-doped SiO₂ (n_{core}=1.456).

The lateral cladding 7 is realized in BPSG, having a refractive index of nₗₐₜₑᵣₐₗ=1.446.

The upper cladding 6, having a thickness of 10 μm, is realized in SiO₂.

The first and second plurality 8, 9 of grating trenches 11 forming the grating structure have a width W_{T} of 3 μm and a height H_{T} of 4.5 μm, and are filled with air (nₐᵢᵣ=1). Therefore the refractive index difference is Δn_{G}=0.446.

The distance of the trenches 11 from the core is d=500 nm. The grating period is equal to 536 nm with a duty cycle of 50%.

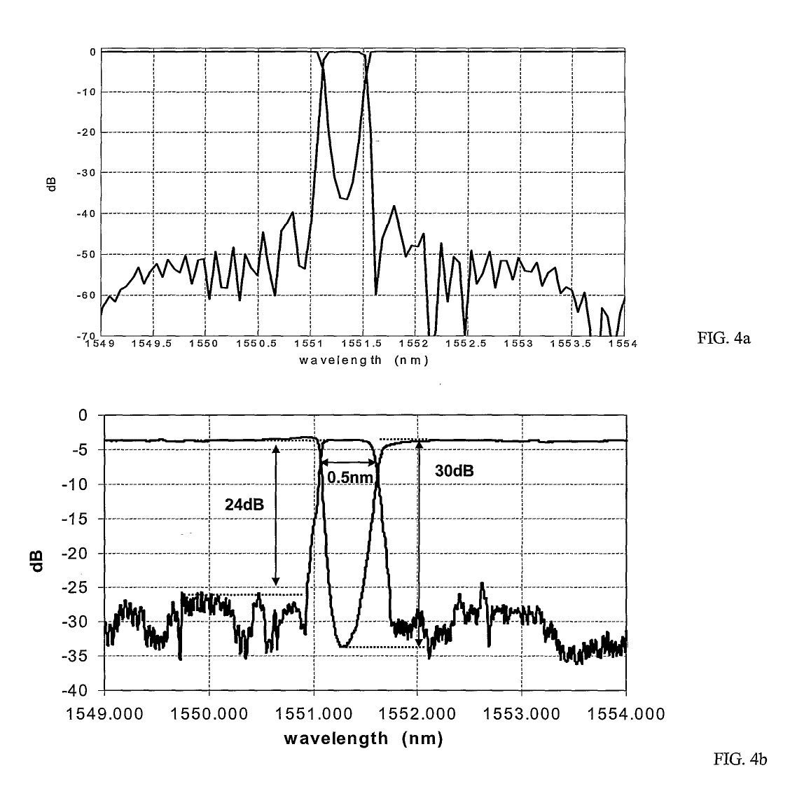

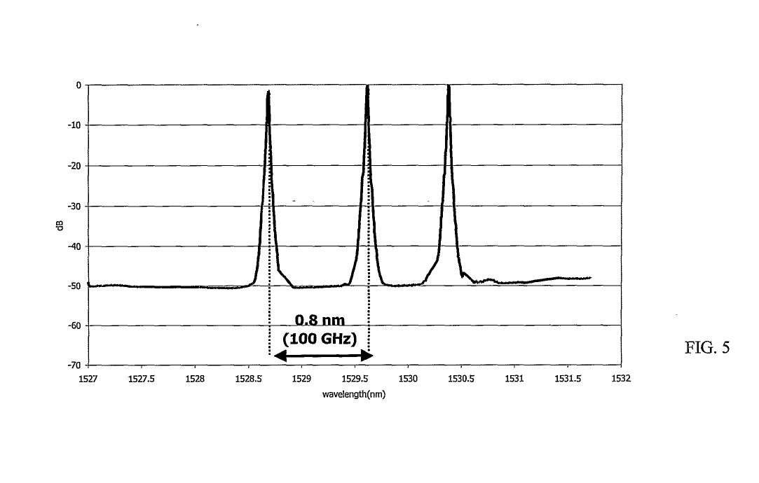

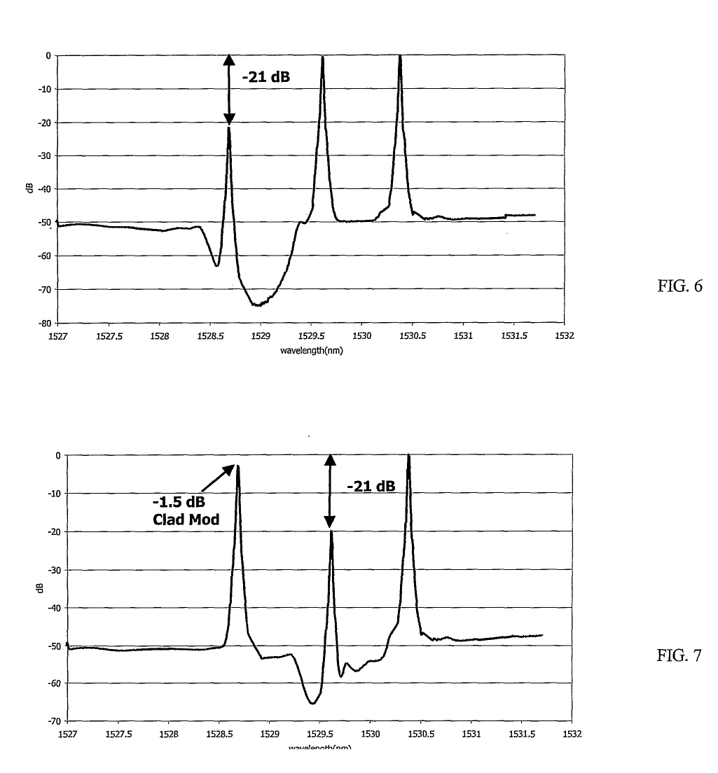

Considering an input signal applied to an input port 21 of the filtering element 100 comprising a plurality of channels having wavelengths spaced apart as depicted in FIG. 5, the optical response of the filtering element so realized as described in this example is shown in FIGS. 4a and 4b.

In particular, the two solid lines drawn in each figure show the simulated (FIG. 4a) and experimental (4b) transmission spectrum and reflection spectrum of the filtering element.

The filtering element 100 can be thermo-optically tuned. In FIGS. 6 and 7 the spectra response of the filtering element 100 at two different operating temperature are shown: FIG. 6 shows the response at 25° C., whilst FIG. 7 shows the filtering action of the grating at 65° C. An input signal containing three different channels (having three different wavelengths λ₁, λ₂ and λ₃) enters the filtering element 100, and the output signal of the filtering element 100 depicted in FIG. 6 shows that the first channel λ₁ undergoes a 21 dB suppression at 25° C. On the other hand, as shown in FIG. 7, the second channel λ₂ of the same input signal undergoes a 21 dB suppression at 65° C. A 1.5 dB suppression (see FIG. 7) of the first wavelength is due to cladding modes.

In particular, the preferred characteristics of the filtering element 100 are listed in the following table:

| Parameter | Requirement | |
|---|---|---|
| Channel spacing | 100 | GHz |
| Operating bandwidth | >30 | nm |
| Drop Loss | <3 | dB |
| Add Loss | <3 | dB |
| Filter Bandwidth (@ −1 dB) | >25 | GHz |
| Tuning Bandwidth (in 3^{rd} optical window) | 30 | nm |
| Polarization Dependent Loss | <0.2 | dB |

Where the following definitions apply:

Drop Loss: insertion loss of a dropped channel.

Add Loss: insertion loss of an added channel.

Tuning Bandwidth: maximum operating range of each tunable filter.

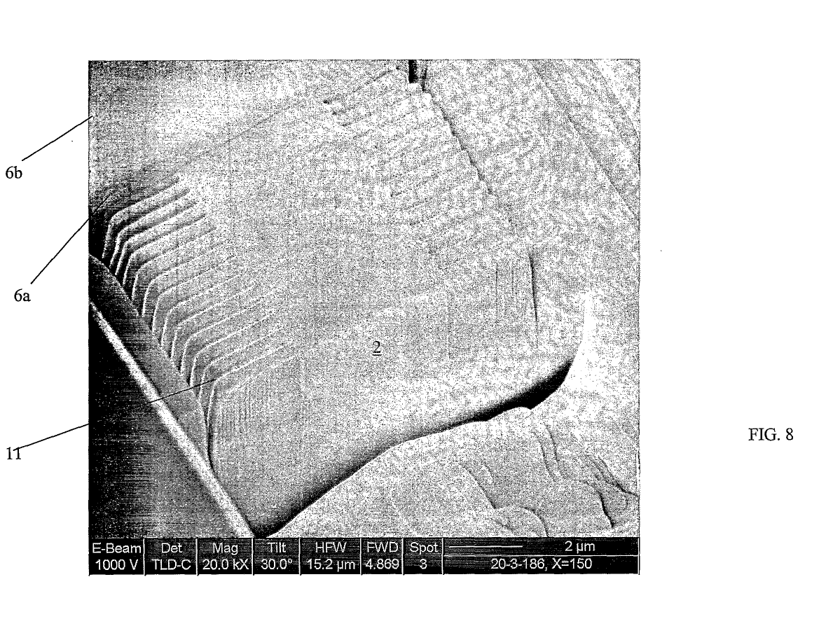

A SEM picture, obtained by Focused Ion Beam (FIB) technique, of the realized device 100 is shown in FIG. 8. The filtering element 100 is partially sectioned in order to show the trenches 11 and the upper cladding 6 comprising two different layers 6a, 6b.

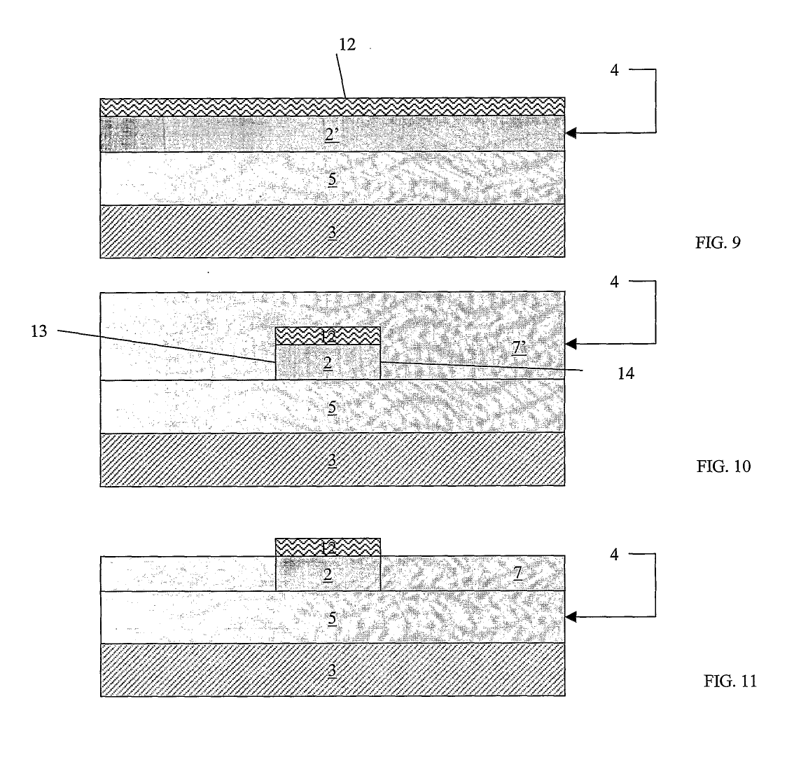

With reference now to FIGS. 9-15, fabrication of the planar waveguide 4 of the invention according to a preferred embodiment is described. A lower cladding layer 5, for example of undoped SiO₂, is deposited on the substrate 3. A core layer 2′ is thus deposited on top of the lower cladding layer 5′. The core and lower cladding layers may be deposited according to any suitable standard technique such as Chemical Vapor Deposition (CVD).

A masking layer 12 is then deposited on top of the core layer 2′, in order to protect the latter layer during the subsequent etching process. Any masking material selective on the core layer material may be used, for example a polysilicon layer may be employed, which is deposited for example by Low Pressure Chemical Vapor Deposition (LPCVD). This configuration is shown in FIG. 9.

The patterning of the core layer 2′ in order to obtain the core 2 of the waveguide 4 is thus realized by optical lithography using the masking layer 12 as a mask after appropriate patterning. For example the core 2 may be patterned using a dry etching phase.

A lateral cladding layer 7′, for example realized in BPSG, is then deposited on top of the patterned core 2, of the remaining portions of the masking layer 12 used to etch the core 2, and of the lower cladding layer 5, as shown in FIG. 10.

Preferably, after deposition, the top surface of the lateral cladding layer 7′ is planarized. A standard planarization technique might be used, such as Chemical Mechanical Polishing (CMP).

The lateral cladding layer 7′ is then etched in order to reduce its thickness up to the height of core 2, to obtain the lateral cladding 7 (FIG. 11). A portion of the masking layer 12 still covers the core 2 during this etching phase, and it is subsequently removed.

The trenches 11 forming the two pluralities 8, 9 are preferably realized on the lateral cladding layer 7 using electron beam lithography, although sub-micron optical-lithography can be used as well

The lateral cladding layer 7 is therefore covered by a resist suitable for use in electron beam lithography. The resist layer can be for example a positive resist layer made of UV6™.

The electron beam transfers therefore the desired pattern (the lines of the trenches 11) onto the resist layer during the writing process. Preferably, the two gratings patterns are realized at the same time. More generally, multiple desired patters are created in a single writing process.

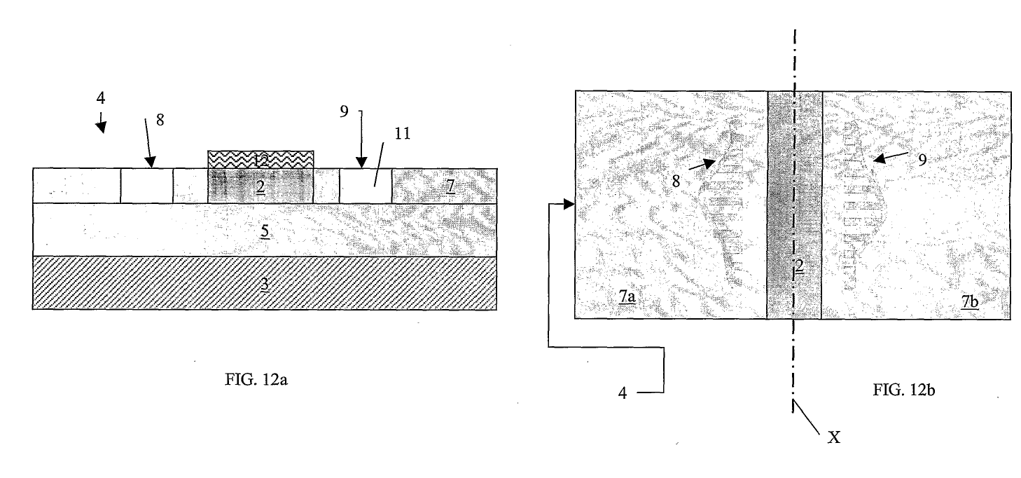

The desired pattern may include parallel lines with a constant pitch, as in the preferred embodiment depicted in FIG. 1, however in other embodiments the pattern may include other configurations of parallel lines. For example, in the embodiment of FIG. 12b an apodized grating structure is realized by maintaining a constant pitch and modulating the length of the trenches along the grating length.

The resist layer is thus developed in a standard way to resolve the grating patterns. The patterns are then transferred in the lateral cladding layer 7 by Deep Reactive Ion Etching using the resist mask patterned using e-beam to protect the un-etched portions. The resulting configuration is shown in FIGS. 12a, 12b in which the trenches lines 11 are visible in cross-section and from above respectively. Preferably the trenches are empty, i.e. filled with air.

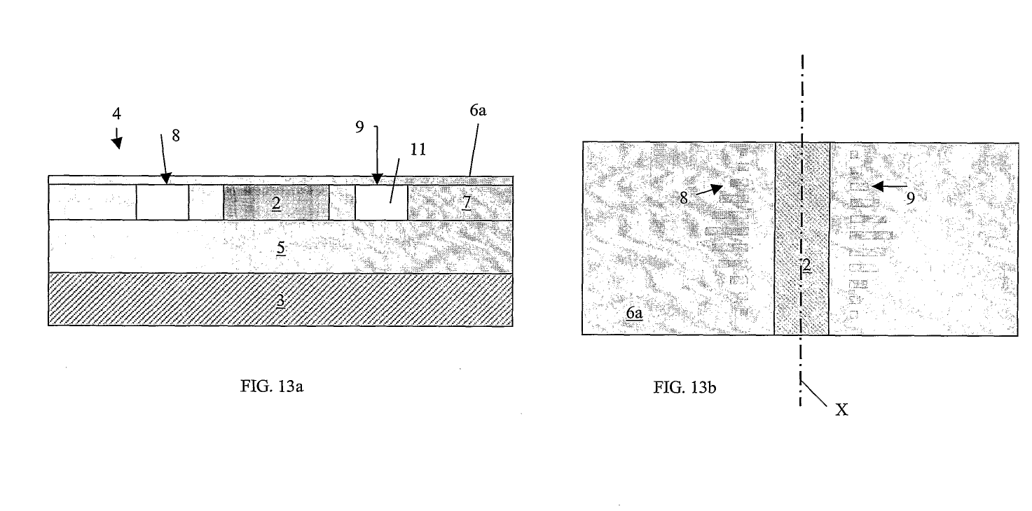

An upper cladding layer 6 is thus deposited over the so-formed first and second plurality of trenches 8, 9 realizing a grating structure and over the core 2 of the waveguide 4. In particular, a first upper cladding layer 6a is deposited on said structure preferably using Plasma Enhanced Chemical Vapor Deposition (PECVD). This phase is shown in FIGS. 13a and 13b. Preferably, the first upper layer 6a is realized in fluorine-doped silicon oxide and it has a relative low thickness, for example of the order of 1 μm. The choice of the material and of the thickness of the layer is made in such a way that the filling of the trenches 11 by portions of the upper cladding material is essentially avoided.

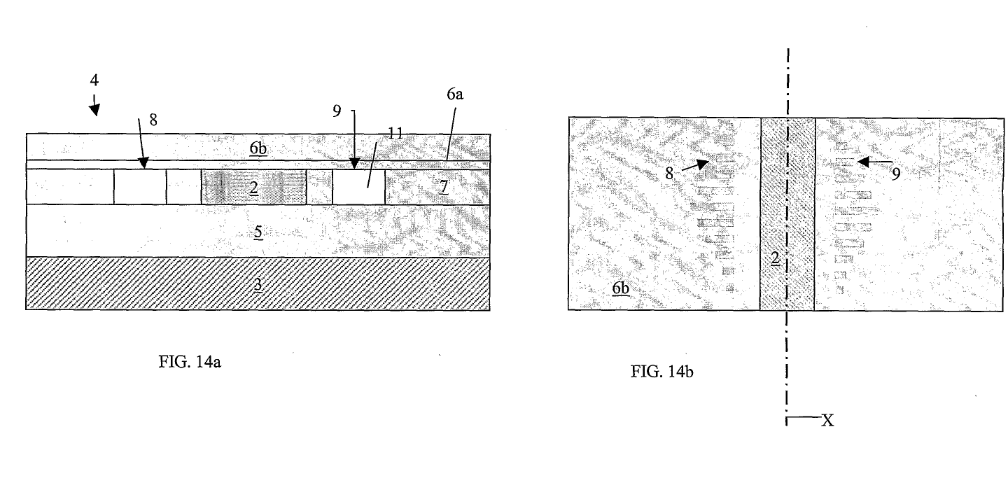

A second upper cladding layer 6b is then deposited on top of the first layer 6b, in order to form the upper cladding 6, so that the overall thickness of the upper cladding layer 6 is of the order of the lower cladding layer 5. See for example FIGS. 14a and 14b for the resulting configuration.

Preferably, in order to form the above mentioned microheater(s) 20 to tune the grating structure, a metallic layer is deposited on top of the upper cladding layer 6 on which metallic contacts 20 are thus patterned (FIG. 15).

### EXAMPLE 2

A filtering element 100 is realized following the process outlined below.

On top of a silicon wafer 3, a SiO₂ layer (the lower cladding 5) is realized by thermal oxidation, having a thickness of 10 μm. On top of this layer, a core layer 2′ which is made of Ge-doped SiO₂ and which has a thickness of 4.4 μm, is deposited using PECVD.

The core layer 2′ is thus covered by a polysilicon layer 12, 0.5 μm thick, deposited using LPCVD. The polysilicon layer 12 and the core layer 2′ are thus patterned using a dry etching technique.

The BPSG lateral cladding layer 7′ is then deposited by Atmospheric Pressure Chemical Vapour Deposition (APCVD) on top of the core 2 and lower cladding 5, with an initial thickness of 8.5 μm, and it is then planarized using CMP. The BPSG layer in excess is then removed through etching (etchback phase) up to the core height.

The portion of polysilicon layer remained on top of the core 2 is thus removed.

The trenches 11 are realized using electron-beam lithography. In particular a resist layer made of UV6 having a thickness of 1.7 μm is deposited on top of the BPSG lateral cladding, which is then patterned by e-beam. A Deep Reactive Ion Etching (DPRIE) phase realizes the two pluralities of trenches 8, 9 forming the grating structure in the BPSG layer.

Using Plasma Enhanced Chemical Vapour deposition, a silicon oxide layer 6a containing fluorine atoms is deposited on top of the core 2 and lateral BPSG cladding layer 7 (and thus over the trenches therein formed), forming the first upper cladding 6a. The thickness of this layer is 1 μm.

A second SiO₂ upper cladding layer 6b having a thickness of 9 μm is deposited on top of the first layer 6a.

A metal layer (not shown) is deposited on top of the second upper cladding layer and microheaters 20 are patterned.

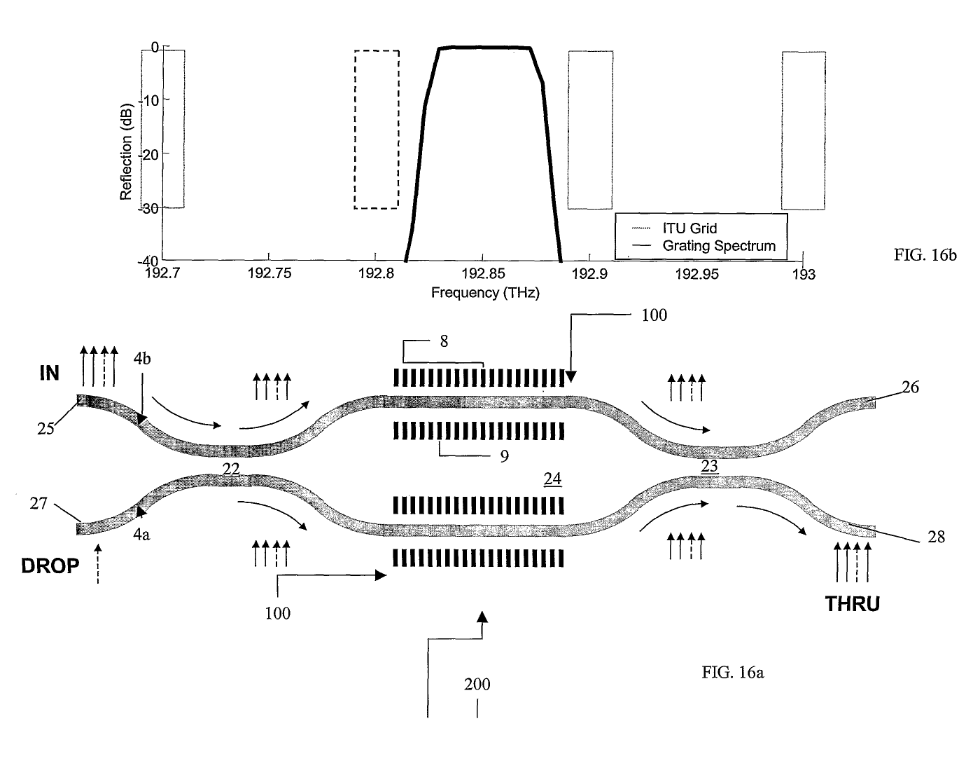

The filtering element 100 of the present invention can be a simple system as depicted in FIG. 1 comprising a single waveguide 4 with two lateral pluralities of trenches 8, 9, or it can be a more complex device. In FIGS. 16a-18a a preferred embodiment of a filter 200 according to the invention is shown. The filter 200 is in the form of a Mach-Zehnder interferometer (MZI). The MZI 200 comprises two substantially identical planar waveguides 4a, 4b, in the same substrate 3, which form two 3-dB coupling regions 22,23. As an example, the coupling regions may form directional couplers or multimode interference (MMI) couplers.

Between the two coupling regions 22,23, a grating region 24 is defined in which two couples of plurality of trenches 8,9 are formed, each couple of plurality of trenches 8,9 being realized as described above in the waveguide 4. Each couple of plurality of trenches form a grating structure and the couple of grating structures form a grating system.

Each waveguide 4a,4b of the MZI comprises a couple of plurality of trenches. The waveguides 4a,4b are shown in the embodiment of FIGS. 16a-18a spaced apart from each other at sufficient distance so that evanescent coupling between the waveguide cores of the two arms does not occur in the grating region.

The first waveguide 4a of the MZI comprises an input port 25 and an add port 26, while the second waveguide 4b defines a drop port 27 and a through port 28.

A light signal including a plurality of channels, for example four different 100 GHz spaced ITU channels (λ₁, λ₂, λ₃, λ₄), enters the filter 200 through the input port 25. In a first operative condition depicted in FIG. 16a, none of the channels of the input signal is resonant with the grating system, therefore all the channels pass undisturbed through the port 28. Indeed, the reflection bandwidth of the grating system, depicted in FIG. 16b, shows that the input channels lie outside its width.

It is to be understood that the number of channels in the input signal can be arbitrary, the number of four being an example.

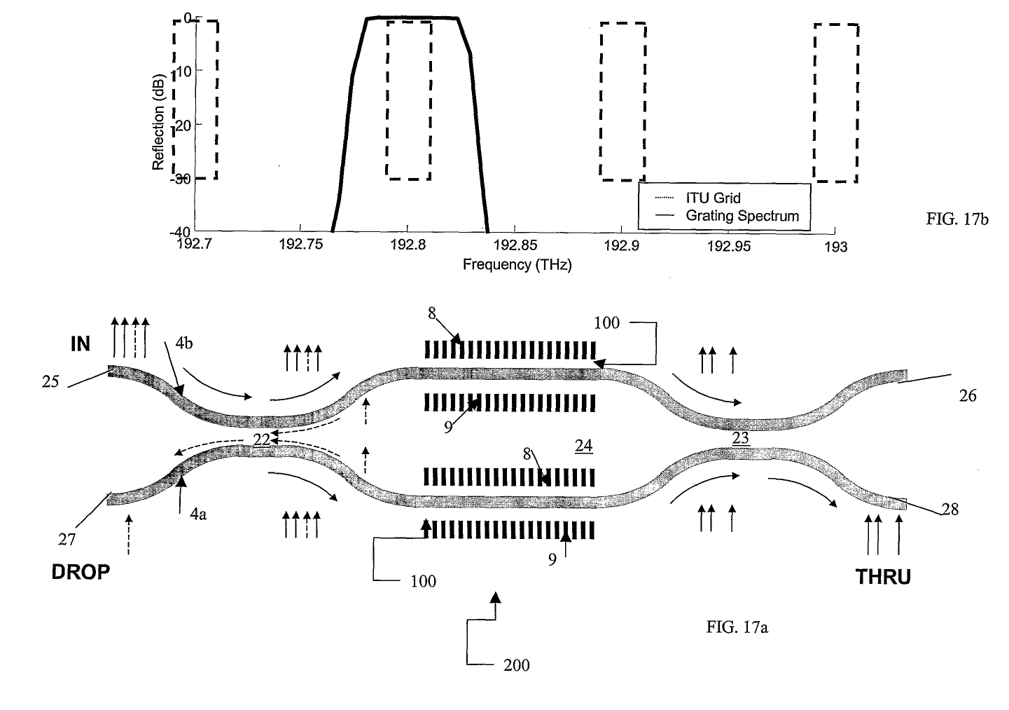

In a second operative condition of the same filter 200, called “drop” configuration and shown in FIG. 17a, the input signal comprising four different 100 GHz spaced ITU channels enters the filter through the input port 25. In this case, the wavelength λ₃ is resonant with the grating system (this can be clearly seen from FIG. 17b). This resonant wavelength, the one indicated with a dotted arrow in FIG. 17a, exits the MZI through the drop port 27, whilst the remaining wavelengths λ₁, λ₂, λ₄ propagate through the grating system to the output port 28.

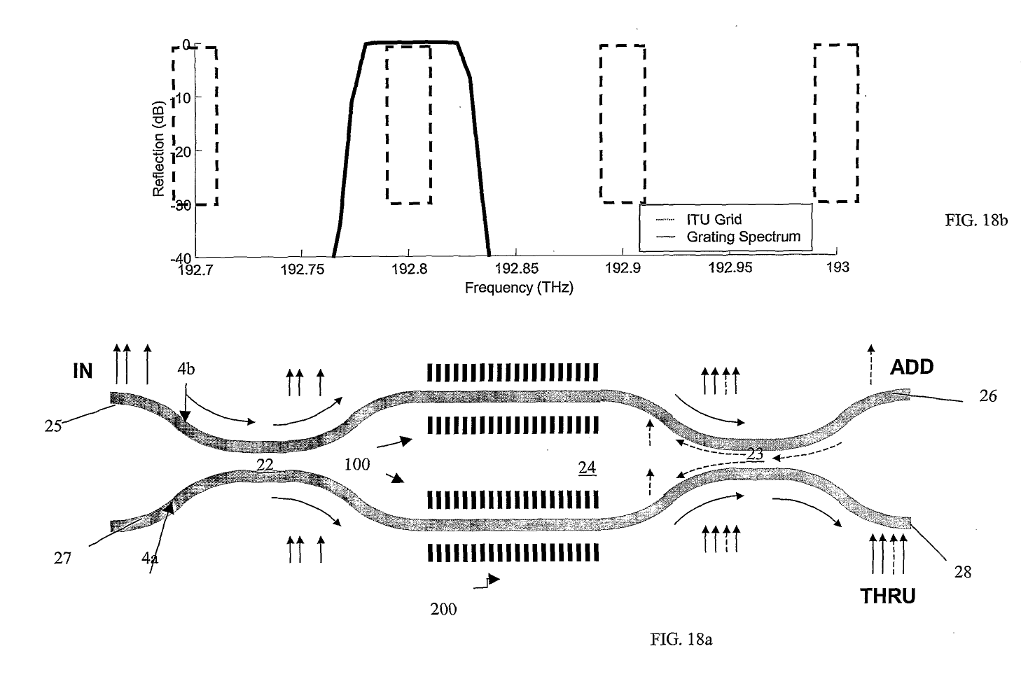

In a third operative condition shown in FIGS. 18a and 18b, a 3-channels (λ₁, λ₂, λ₄) input signal enters the filter through the input port 25. An additional wavelength λ₃ enters the filter at the add port 26, said wavelength being in resonance with the grating system (see FIG. 18b). As shown in FIG. 18a, all the wavelengths (λ₁, λ₂, λ₃, λ₄) exit the filter 200 at the port 28, therefore the additional wavelength has been added to the input signal.

Preferably, the total length of each plurality of trenches (i.e. the total length measured along the X direction) is comprised between 9 mm and 11 mm.

Preferably, the MZI 200 comprises a tuning element such as the heater described above, so that the wavelength which is resonant with the grating system can be tuned. Therefore the dropped or added wavelength can be selected accordingly.

For example, the same filter 200 can be used in the first and in the second operative condition above described simply shifting (by varying the temperature) the wavelength at which the grating system is resonant. Additionally, a different tuning can be made such that, instead of λ₃, a different wavelength is added/dropped. For a given temperature range, a given tuning range of the added/dropped wavelength is given, depending on the thermo-optic coefficient of the materials used to fabricate each planar waveguide 4a,4b.

Preferably, for an input signal comprising channels having a 100 GHz spacing, a single filter 200 is used to add/drop two channels.

Therefore, given the number of channels and their spacing, a device comprising a number of filters 200 can be realized in order to multiplex/demultiplex the input signal.

In FIG. 19a, a two-channel add/drop device 500 including two filters 200a, 200b connected in cascade is disclosed. In this case, each filter 200a, 200b comprises two grating systems Gr 1, Gr 2, Gr 3 and Gr 4 respectively, each grating system selecting a single channel.

In operating condition, an input signal including four different channels (λ₁, λ₂, λ₃, λ₄) enters the input port 25 of the first filter 200a.

The second wavelength λ₂ is in resonance with the grating system Gr 2 of the first filter 200a and thus the second wavelength is dropped through the drop port 27 of the first filter 200a, while the remaining wavelengths exit the through port 28 of the first filter 200a which is at the same time the input port of the second filter 200b. The fourth wavelength λ₄ is in turn resonant with the grating system Gr 4 of the second filter 200b and thus this wavelength is dropped by the drop port 30 of the second filter 200b while the remaining wavelengths λ₁, λ₃ exit the second filter 200b through its through port 31. The reflection spectra of the grating systems Gr, Gr 2, Gr 3, Gr 4 realized in this device is shown in FIGS. 19b, 19c, 19d and 19e.

Preferably, the total length of each plurality of trenches (i.e. the total length measured along the X direction) fabricated in the device 500 is comprised between 5 mm and 6 mm.

By changing the temperature of the waveguide(s) in which the grating systems are formed, the dropped wavelengths may be changed, so that only one wavelength or none can be dropped accordingly (see for example the dotted line of FIG. 19d).

Employing the same multi-stage system described above, 4-channel, 8-channel, etc add/drop devices may be constructed in accordance to the present invention.

1-24. (canceled)

25. A wavelength selective grating-based filter, comprising:
a planar waveguide comprising a core surrounded by a cladding, said cladding comprising a lower cladding, the core being placed above the lower cladding, a lateral cladding adjacent to a first and a second opposite lateral sides of the core, and an upper cladding, said upper cladding being positioned above said core and lateral cladding; and
a grating structure comprising a first and a second plurality of grating trenches formed in said lateral cladding in proximity of said first and second opposite lateral sides of the core, respectively, said first and second plurality of grating trenches being covered by said upper cladding.

26. The filter according to claim 25, wherein the refractive index contrast of the grating structure is not smaller than 0.4.

27. The filter according to claim 25, wherein the effective refractive index contrast of the grating structure is between 1×10⁻⁴≦Δn_{eff}≦2−3×10⁻³.

28. The filter according to claim 25, wherein said first and said second plurality of grating trenches are disposed symmetrically with respect to a longitudinal axis of said core.

29. The filter according to claim 25, wherein the height of said grating trenches is substantially equal to the height of said core.

30. The filter according to claim 25, wherein said grating trenches are filled with air.

31. The filter according to claim 25, wherein the distance between said first or second lateral side of the core and said first or second plurality of grating trenches is not smaller than 50 nm.

32. The filter according to claim 31, wherein the distance between said first or second lateral side of the core and said first or second plurality of grating trenches is 50 nm to 2500 nm.

33. The filter according to claim 32, wherein the distance between said first or second lateral side of the core and said first or second plurality of grating trenches is 100 nm to 1000 nm.

34. The filter according to claim 25, wherein said core comprises one or more silicon compound materials.

35. The filter according to claim 25, wherein said cladding comprises one or more silicon compound materials.

36. The filter according to claim 25, wherein the refractive index of said core is 1.448 to 3.5.

37. The filter according to claim 25, wherein the refractive index of said cladding is 1.446 to 3.5.

38. The filter according to claim 25, wherein the refractive index difference between the refractive index of the lateral cladding and the refractive index of the upper cladding is of the order of 10⁻⁴ or lower.

39. The filter according to claim 25, wherein the cross-section of said core is square.

40. The filter according to claim 39, wherein the relative refraction index difference between the core and the cladding of said planar waveguide is 0.6% to 0.7%.

41. The filter according to claim 27, wherein said first and second plurality of grating trenches have a period of 100 nm to 600 nm.

42. The filter according to claim 27, wherein said first and second plurality of grating trenches preferably have a duty cycle of 10% to 90%.

43. The filter according to claim 25, wherein the width of said grating trenches is 0.5 μm to 10 μm.

44. The filter according to claim 25, wherein said core and/or said cladding comprise(s) a tunable material.

45. The filter according to claim 44, wherein said tunable material is a thermo-optic material.

46. The filter according to claim 25, comprising one or more heaters.

47. A Mach-Zehnder filter comprising one or more of said filters according to claim 25.

48. An add/drop optical device comprising one or more filters according to claim 25 and/or one or more Mach-Zehnder filters comprising one or more filters according to claim 25.
